(19) United States
(12) Patent Application Publication
(10) Pub. No.: US 2010/0116006 A1
(43) Pub. Date: May 13, 2010

(54) STRIKE LOCK WITH FUNCTIONS OF FAIL SECURITY AND FAIL SAFETY

(76) Inventor: Chien-Ying Huang, Taichung (TW)

Correspondence Address: Chien-Ying Huang, 235 Chung - Ho Box 8-24, Taipei, 235, TW

(21) Appl. No.: 12/266,556

(22) Filed: Nov. 7, 2008

(51) Int. Cl. E05B 65/00

(52) U.S. Cl. 70/91

(57) ABSTRACT

A strike lock includes an upper frame, a lower frame, a door position detector, a door position detecting spring, an electromagnetic tube, a detecting switch assembly, a buckle assembly, a press assembly, and a lock assembly. The detecting switching assembly is formed by a door position detecting switch, a substrate, and an electromagnetic tube detecting switch. The buckle assembly is formed by a buckle, a buckling spring, and a straight screw. The press assembly is formed by a positioning plate, a press unit, a pressing spring, and a positioning screw. The lock assembly is formed by a lock, a support unit, and a locking spring. The operation of the strike lock is that the electromagnetic tube moves transversally to push the buckle assembly, when the press assembly can move downwards to buckle the buckle assembly, the locking spring and the lock are free to move to have the object of door unlocking. When the press assembly cannot move downwards to buckle the buckle assembly, the locking spring and the lock are locked by the press assembly to have the object of door locking. The operation of the strike lock is that when the electromagnetic tube is excited to move the buckle assembly transversally, the press assembly is able to move downwards and the lock is free to move so as to have the object of an electric lock. Through changing the installation direction of the buckle, the functions of unlocking the door under power supplying or power interruption are switched.

### FIELD OF THE PRESENT INVENTION

The present invention relates to lock, and in particular to a strike lock has functions of fail security and fail safety.

### BACKGROUND OF THE INVENTION

Because of complicated components and manufacturing processes and the high cost of the prior mechanical locks, electrical locks are developed to solve the issues mentioned-above, while the electrical lock still has following disadvantage in usage and manufacturing.

1. The prior electrical lock is not suitable for all specification of door width. Various types of electrical lock need to be produced for meeting the various specifications.

2. The prior electrical lock usually has only one function of fail security or fail safety. The usage of the lock is thus limited.

Thus, the prior electrical lock mentioned above is not a good design and still needs to be improved.

Regarding to the disadvantages of the prior electrical lock, the inventor of the present invention spends years and efforts to research and successfully develops an improved structure of the strike lock.

### SUMMARY OF THE PRESENT INVENTION

Accordingly, the primary object of the present invention is to provide a lock with both functions of unlocking the door under power supply period and power off state to select, and through changing a buckle to switch the functions.

A secondary object of the present invention is to provide a strike lock suitable for various specifications of door widths.

Another object of the present invention is to provide a strike lock with advantages of simple components, easy installation, easy maintenance, long lifetime, and low manufacturing cost.

To achieve the above object, the present invention provides a strike lock includes an upper frame, a lower frame, a door position detector, a door position detecting spring, an electromagnetic tube, a detecting switch assembly, a buckle assembly, a press assembly, and a lock assembly. The detecting switching assembly is formed by a door position detecting switch, a substrate, and an electromagnetic tube detecting switch. The buckle assembly is formed by a buckle, a buckling spring, and a straight screw. The press assembly is formed by a positioning plate, a press unit, a pressing spring, and a positioning screw. The lock assembly is formed by a lock, a support unit, and a locking spring. The operation of the strike lock is that the electromagnetic tube moves transversally to push the buckle assembly, when the press assembly can move downwards to buckle the buckle assembly, the locking spring and the lock are free to move so as to have the object of door unlocking. When the press assembly cannot move downwards to buckle the buckle assembly, the locking spring and the lock are locked by the press assembly so as to have the object of door locking. The operation of the strike lock is that when the electromagnetic tube is excited to move the buckle assembly transversally, the press assembly is able to move downwards and the lock is free to move so as to have the object of an electric lock. Through changing the installation direction of the buckle, the function of unlocking the door under power supplying or power off is switched.

### BRIEF DESCRIPTION OF THE DRAWINGS

FIG. 1 is an exploded schematic view of the present invention.

FIG. 2 is a solid schematic view of the present invention.

FIG. 3 is a schematic view showing the operation of the present invention.

FIG. 4 is a schematic view showing the operation of the present invention about unlocking door under power off state.

FIG. 5 is a schematic view showing the operation of the electromagnetic tube under power off when the present invention functions in fail safety mode.

FIG. 6 is a schematic view showing the operation of the electromagnetic tube under power supplying when the present invention functions in fail safety mode.

FIG. 7 is a schematic view showing the operation of the present invention about fail security mode.

FIG. 8 is a schematic view showing the operation of the electromagnetic tube under power off when the present invention functions in fail security mode.

FIG. 9 is a schematic view showing the operation of the electromagnetic tube under power supplying when the present invention functions in fail security mode.

FIG. 10 is a schematic view showing the assembly of the present invention.

FIG. 11 is a schematic view showing an embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

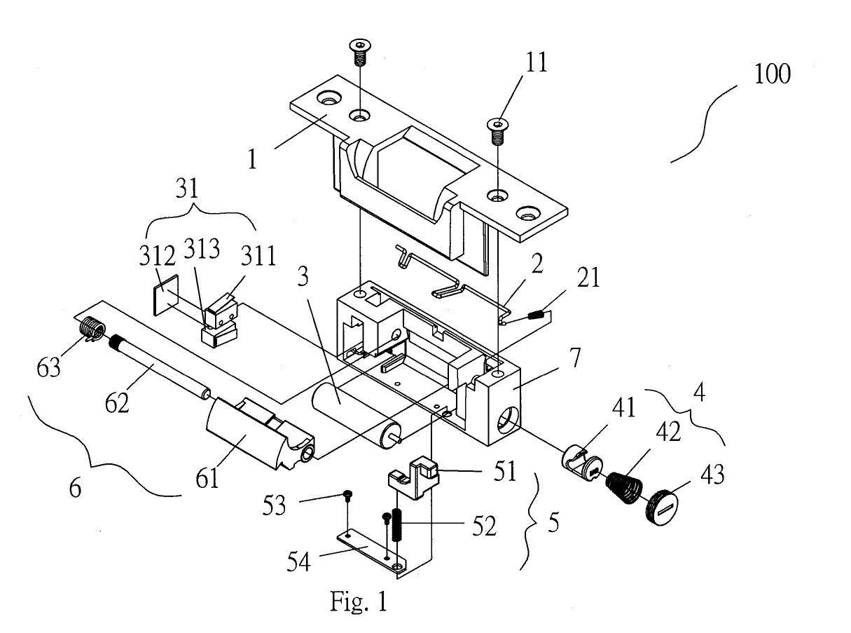

With reference to FIG. 1, an exploded schematic view of a strike lock according to the present invention is illustrated. From the drawing, it is known that the strike lock 100 is formed by an upper frame 1, a lower frame 7, a door position detector 2, a door position detecting spring 21, an electromagnetic tube 3, a detecting switch assembly 31, a buckle assembly 4, a press assembly 5, and a lock assembly 6.

The detecting switching assembly 311 is formed by a door position detecting switch 311, a substrate 312, and an electromagnetic tube detecting switch 313. The buckle assembly 4 is formed by a buckle 41, a buckling spring 42, and a straight screw 43. The press assembly 5 is formed by a positioning plate 54, a press unit 51, a pressing spring 52, and a positioning screw 53. The lock assembly 6 is formed by a lock 61, a support unit 62, and a locking spring 63.

The operation of the present invention is that when the electromagnetic tube 3 moves transversally to push the buckle assembly 4, and then the press assembly 5 moves downwards to buckle the buckle assembly 4, the locking spring 63 and the lock 61 are free to move so as to have the object of door unlocking. When the press assembly 5 cannot move downwards to buckle the buckle assembly 4, the locking spring 63 and the lock 61 are locked by the press assembly 5 so as to have the object of door locking. The electromagnetic tube detecting switch 313 of the detecting switch assembly 31 serves to detect whether the electromagnetic tube 3 moves. The door position detecting switch 311 of the detecting assembly 31 detects whether the door is closed by detecting the motions of the door position detector 2 and the door position detecting spring 21. Thus the strike lock according to the present invention is illustrated.

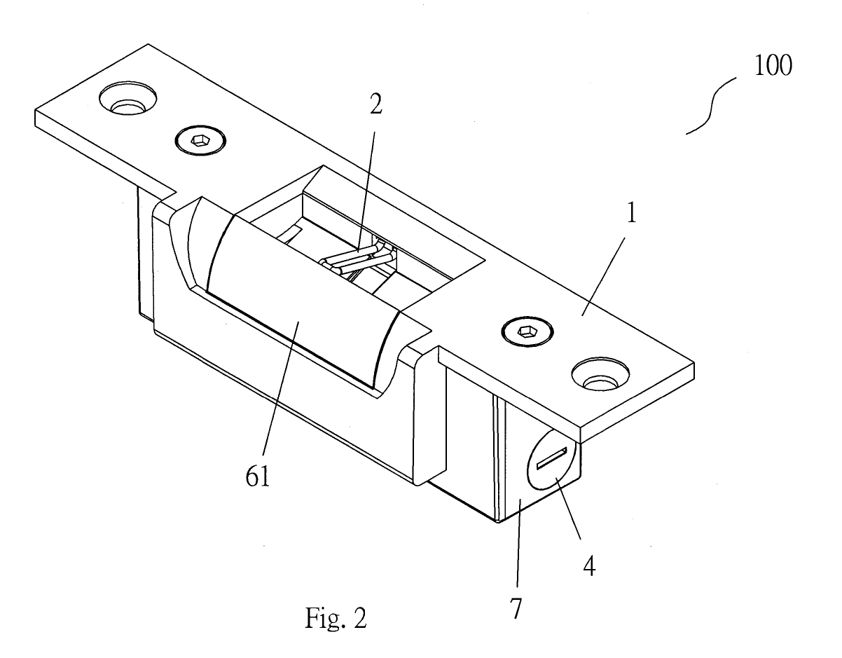

With reference to FIG. 2, a perspective view of the strike lock according to the present invention is illustrated. From the drawing, it is known that the strike lock is formed by the upper frame 1, the lower frame 7, the door position detector 2, the buckle assembly 4, and the lock 61.

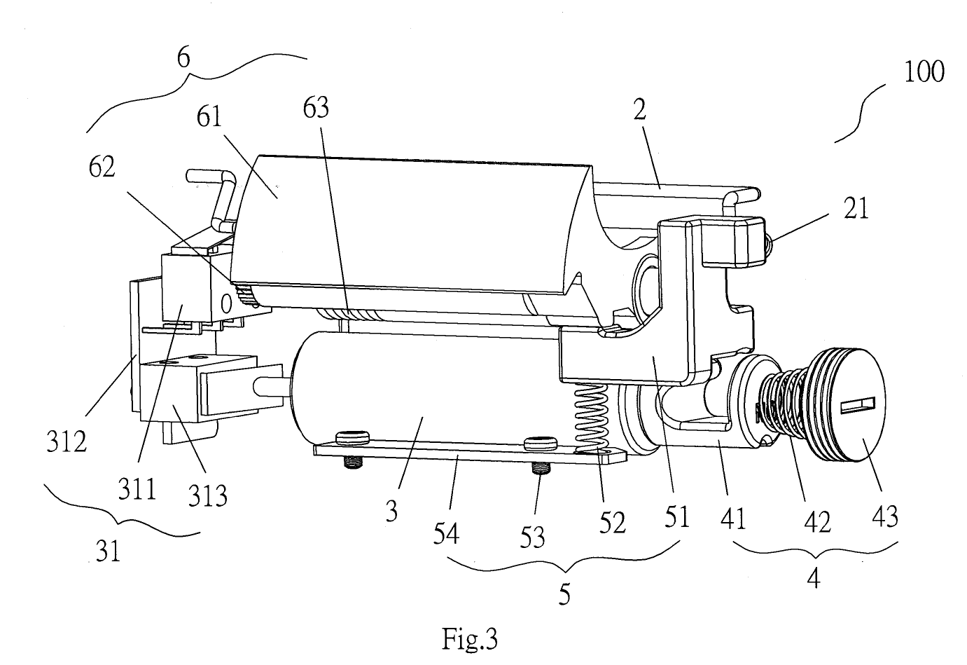

With reference to FIG. 3, a schematic view showing the operation of the present invention is illustrated. From the drawing, it is known that the strike lock is formed by the detecting switch assembly 31, the electromagnetic tube 3, the buckle assembly 4, the press assembly 5, the lock assembly 6, the door position detector 2, and the door position detecting spring 21. The detecting switching assembly 31 is formed by the door position detecting switch 311, the substrate 312, and the electromagnetic tube detecting switch 313. The operation of the present invention is that the electromagnetic tube 3 moves transversally to push the buckle assembly 4 which is formed by the buckle 41, the buckling spring 42, and the straight screw 43. The press assembly 5 is formed by a positioning plate 54, a press unit 51, a pressing spring 52, and a positioning screw 53. When the press assembly 5 moves downwards to buckle the buckle assembly 4, the locking spring 63, the support unit 62 and the lock 61 are free to move so as to have the object of door unlocking. When the press assembly 5 cannot move downwards to buckle the buckle assembly 4, the locking spring 63, the support unit 62 and the lock 61 are locked by the press assembly 5 so as to have the object of door locking. The operation of the present invention is that when the electromagnetic tube 3 is excited to push the buckle assembly 4, the press assembly 5 can move downwards to buckle the buckle 41, thus the lock 61, the support unit 62, and the locking spring 63 are free to move so as to have the object of an electric lock.

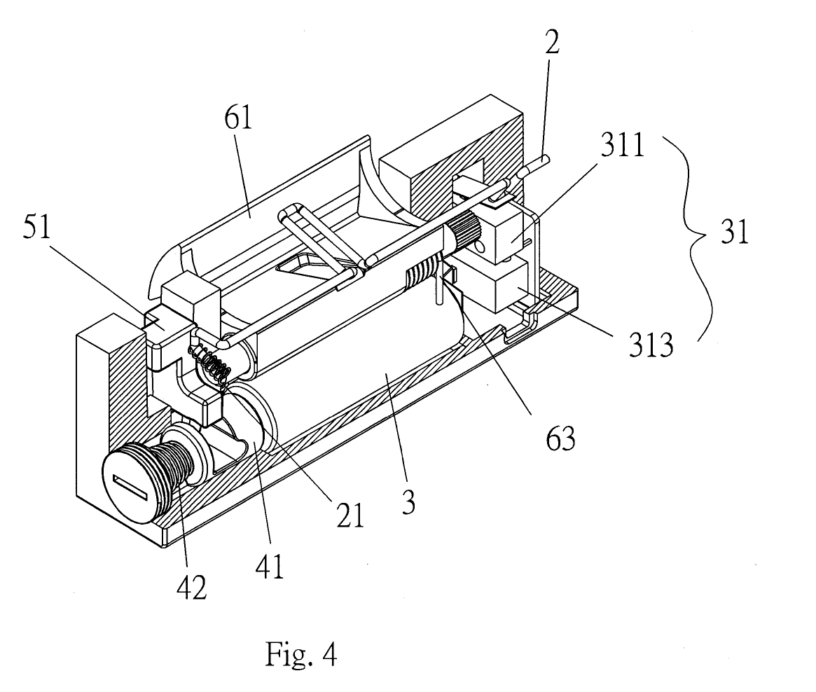

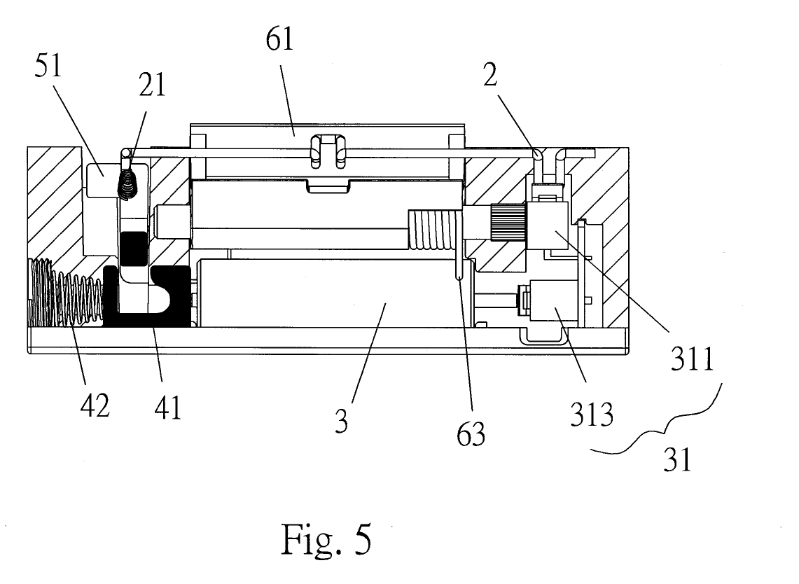

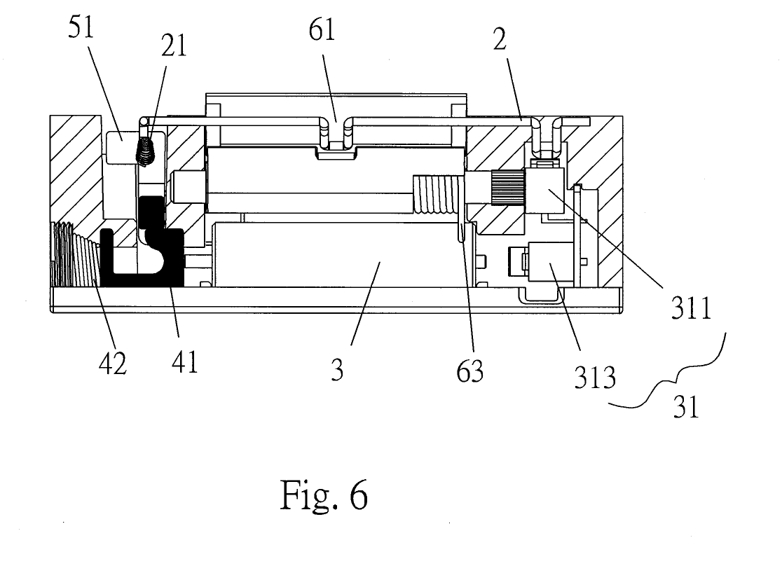

With reference to FIG. 4, a schematic view showing the operation of the present invention about door unlocking under power off state is illustrated. Furthermore, with reference to FIGS. 5 and 6, the schematic views showing the operations of the electromagnetic tube 3 under power supplying and power off are illustrated. The electromagnetic tube 3 will not move during power off state, thus the press unit 51 can be pressed downwards by the lock 61 and the locking spring 63 to buckle the buckle 41 so as to have the object of door unlocking. After power is supplied to the electromagnetic tube 3, the electromagnetic tube 3 will move toward the buckle 41 to push the buckle 41 to a predetermined position, thus the press unit 51 can not be pushed downwards by the lock 61 to buckle the buckle 41 so as to have the object of locking the door. The buckle 41 is pushed by the buckling spring 42 to restore the position when power is off. Therefore, the object of door locking under power supplying and unlocking door under power off state is achieved.

The electromagnetic tube detecting switch 313 of the detecting switch assembly 31 serves to detect whether the electromagnetic tube 3 moves. While the door position detecting switch 311 of the detecting switch assembly 31 detects whether the door is closed by detecting the motions of the door position detector 2 and the door position detecting spring 21.

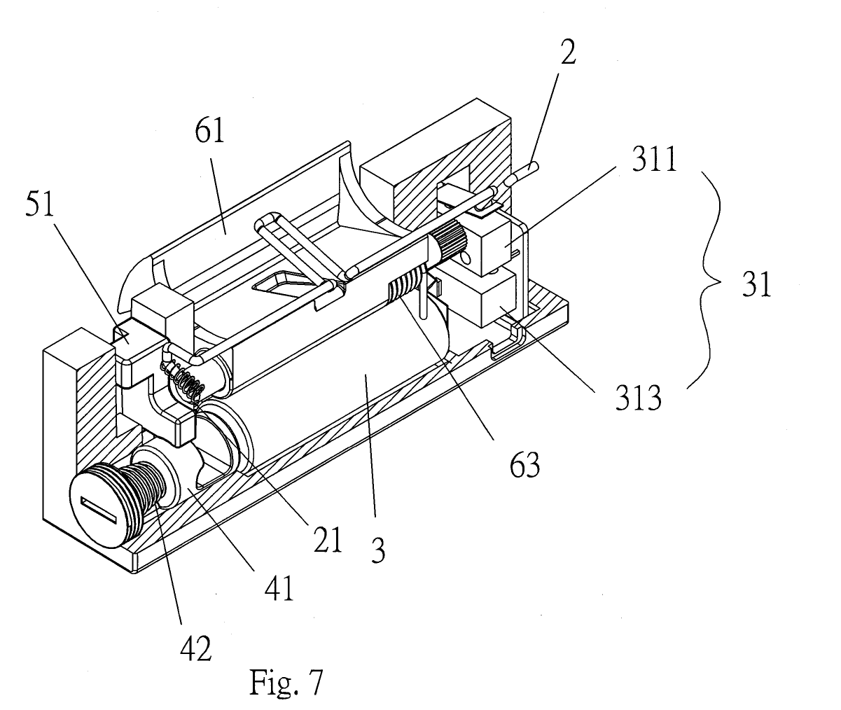

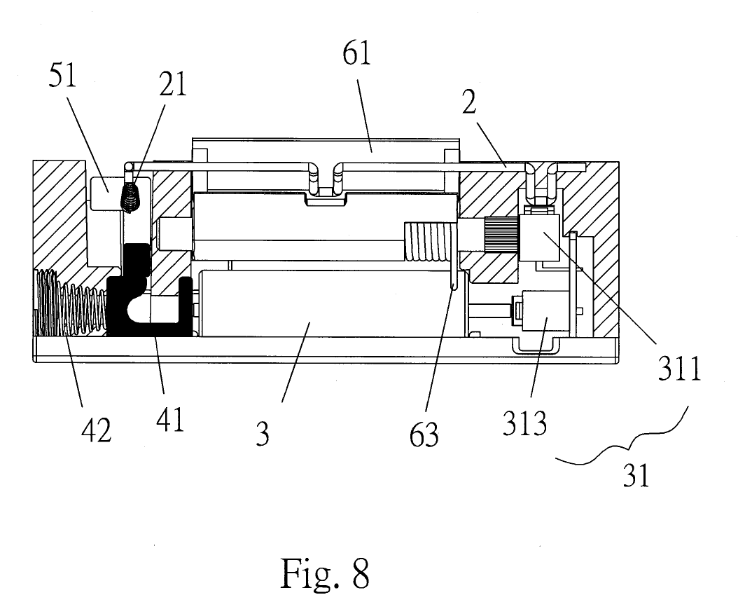

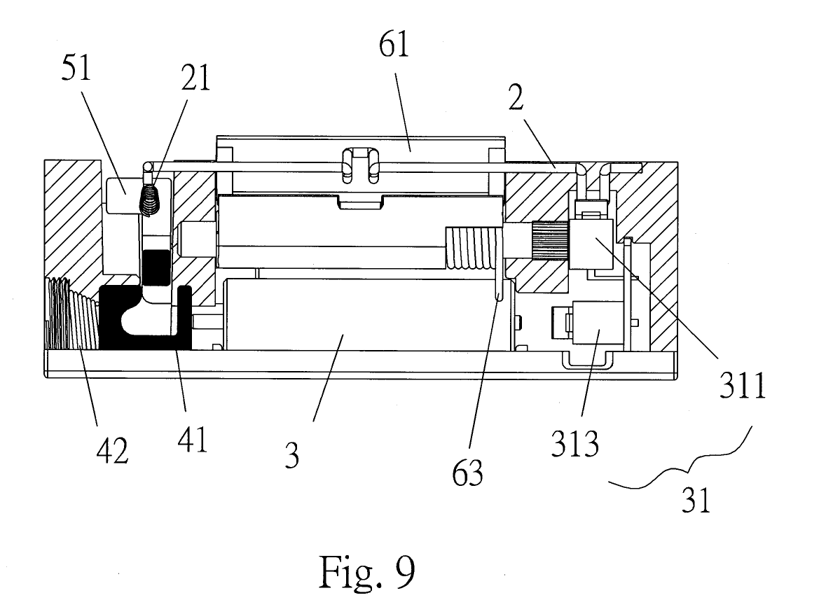

With reference to FIG. 7, a schematic view showing the operation of the present invention about door opening under power supplying is illustrated. Furthermore, with reference to FIGS. 8 and 9, the schematic views showing the operations of the electromagnetic tube 3 under power supplying and power off are illustrated. When power is supplied to the electromagnetic tube 3, the electromagnetic tube 3 will move toward the buckle 41 to push the buckle 41 to a predetermined position, thus the press unit 51 can be pressed downwards by the lock 61 and the locking spring 63 to buckle the buckle 41 so as to have the object of door unlocking. Wherein, the buckle 41 is pushed by the buckling spring 42 to restore the position when power is off. While the electromagnetic tube 3 will be pushed back by the buckle 41 during power off state, thus the press unit 51 cannot be pressed downwards by the lock 61 to buckle the buckle 41. The lock 61 is locked by the press unit 51 so as to have the object of door locking. Therefore, the object of door unlocking under power supplying and door locking under power off state is achieved.

To switch the function of unlocking door between power supplying or power off state, it is only needed to change the installation direction of the buckle 41.

The electromagnetic tube detecting switch 313 of the detecting switch assembly 31 serves to detect whether the electromagnetic tube 3 moves. While the door position detecting switch 311 of the detecting switch assembly 31 detects whether the door is closed by detecting the motions of the door position detector 2 and the door position detecting spring 21.

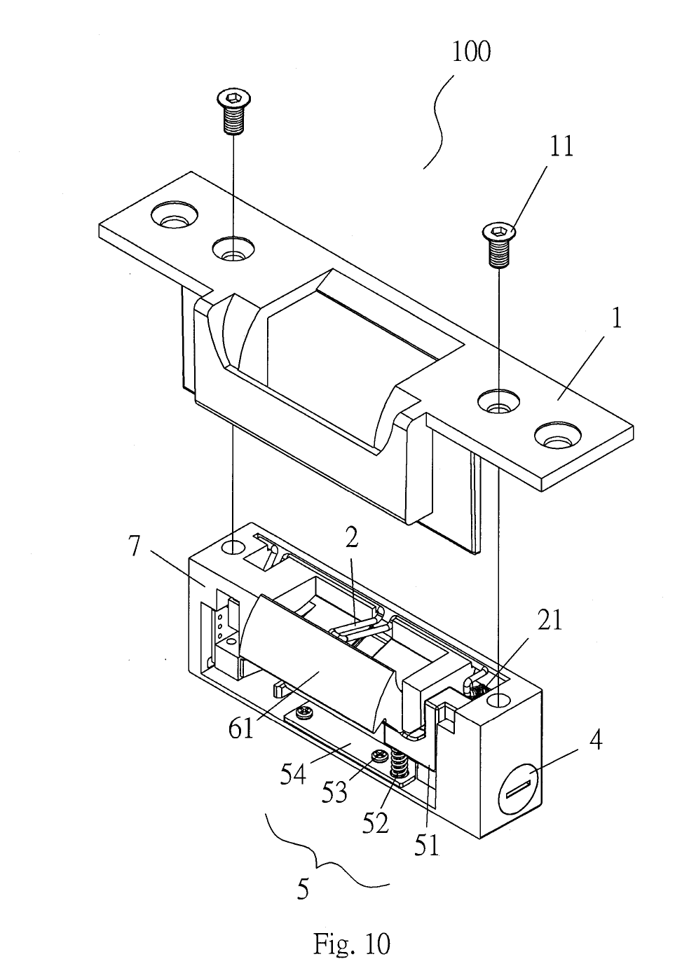

With reference to FIG. 10, a schematic view showing the assembly of the present invention is illustrated. The strike lock 100 of the present invention is assembled by the upper frame 1 and the lower frame 7 through screwed by unscrew-proof bolts 11. The internal structure of the present invention is formed by the door position detector 2, the door position detecting spring 21, the buckle assembly 4, the press assembly 5 which includes the press unit 51, the pressing spring 52, the positioning screw 53 and the positioning plate 54, and the lock 61.

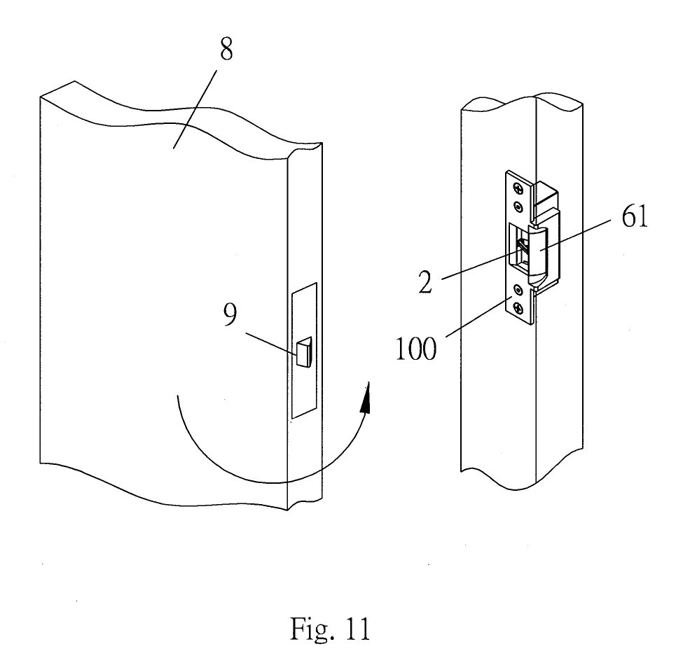

With reference to FIG. 11, a schematic view showing an embodiment of the present invention is illustrated. The strike lock 100 is buckled by a door lock 9 when a door 8 is closed. The door lock 9 will pass through the lock 61 and press the door position detector 2, and an end of the door position detector 2 will press the door position detecting switch 311 for detecting whether the door is closed.

For revealing the improvement and practicability of the present invention, an analysis of the present invention comparing with the prior electric lock which is also the advantage of the present invention is listed in the following.

1. The strike lock of the present invention is suitable for various specifications of door width.

2. The strike lock of the present invention has functions of unlocking door under power supplying and power off state, and is capable of being switched between the functions by modifying the buckle.

3. The strike lock of the present invention has advantages of simple components, easy installation, easy maintenance, long lifetime, and low manufacturing cost.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A strike lock comprising an upper frame, a lower frame, a door position detector, a door position detecting spring, an electromagnetic tube, a detecting switch assembly, a buckle assembly, a press assembly, and a lock assembly, wherein
the detecting switching assembly is formed by a door position detecting switch, a substrate, and an electromagnetic tube detecting switch; the buckle assembly is formed by a buckle, a buckling spring, and a straight screw;
the press assembly is formed by a positioning plate, a press unit, a pressing spring, and a positioning screw; the lock assembly is formed by a lock, a support unit, and a locking spring; and
the operation of the strike lock is that the electromagnetic tube moves transversally to push the buckle assembly, when the press assembly moves downwards to buckle the buckle assembly, the locking spring and the lock are free to move so as to have the object of door unlocking; when the press assembly cannot move downwards to buckle the buckle assembly, the locking spring and the lock are locked by the press assembly to achieve the object of door locking; the operation of the strike lock is that when the electromagnetic tube is excited to push the buckle assembly, the press assembly is able to move downwards and the lock is free to move to achieve the object of an electric lock.

2. The strike lock as claimed in claim 1, wherein the lower frame is installed with a buckle assembly receiving hole and a long protrusion is installed within the receiving hole for limiting the buckle of the buckle assembly as they are placed in the hole without moving linearly.

3. The strike lock as claimed in claim 1, wherein the detecting switch assembly is formed by the door position detecting switch, the substrate, and the electromagnetic tube detecting switch; the electromagnetic tube detecting switch of the detecting switch assembly serves to detect the movement of the electromagnetic tube; while the door position detecting switch of the detecting switch assembly detects the close of the door by detecting the motions of the door position detector and the door position detecting spring.

4. The strike lock as claimed in claim 1, wherein the buckle assembly is formed by the buckle, the buckling spring, and the straight screw; the buckle of the buckle assembly has a Normal Open mark and a Normal Close mark on the two ends thereof for representing the functions of unlocking door under power off or power supplying; to switch the functions of unlocking door under power off or power supplying is to change the installation direction of the buckle; wherein in assembly, the buckling spring in the buckle assembly is buckled to the straight screw to avoid the spring to release as the power is turned off or turned on; a protrusion is installed in the straight screw; when the electromagnetic tube pushes the buckle, the buckle will move forwards inertially, while when the buckle impacts the protrusion of the straight screw, the buckle will stop so as to achieve the object of limiting the buckle.

5. The strike lock as claimed in claim 1, wherein the press assembly is formed by the positioning plate, the press unit, the pressing spring, and the positioning screw.

6. The strike lock as claimed in claim 1, wherein the lock assembly is formed by the lock, the support unit, and the locking spring; the lock of the lock assembly has a slot; the door position detector will locate in the slot when door is closed; the slot will prevent the door position detector from being collided and crashed by the lock during the door is opening.

7. The strike lock as claimed in claim 1, wherein the door position detector and the door position detecting spring detect whether the door is closed; if the door is closed, the strike lock will perform the locking function.

8. The strike lock as claimed in claim 1, wherein the electromagnetic tube moves transversally to push the buckle; a slot is formed on an end of the buckle; when the press assembly is able to move downwards to buckle the buckle in the slot, the locking spring and the lock is able to move so as to have the object of door unlocking; when the press assembly cannot move downwards to buckle the buckle, the lock assembly is locked by the press assembly so as to have the object of door locking; the operation of the strike lock is that when the electromagnetic tube is excited to push the buckle assembly, the press assembly is able to move downwards and the lock is free to move.
